(19) United States
(12) Patent Application Publication
(10) Pub. No.: US 2010/0225773 A1
(43) Pub. Date: Sep. 9, 2010

(54) SYSTEMS AND METHODS FOR CENTERING A PHOTOGRAPH WITHOUT VIEWING A PREVIEW OF THE PHOTOGRAPH

(75) Inventor: Jeffery Lee, Sunnyvale, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/400,386

(22) Filed: Mar. 9, 2009

(51) Int. Cl. H04N 5/228; H04N 5/76; G06K 9/00

(52) U.S. Cl. 348/222.1; 348/231.99; 382/103; 348/E05.031

(57) ABSTRACT

Systems and methods are providing for capturing images of objects or faces without previewing the image to be captured. In particular, systems and methods are provided for using a detection algorithm to determine when a camera lens of an electronic device is properly oriented to capture an item (e.g., a face in a self-portrait). The detection algorithm can be configured to identify specific faces or objects, and can direct the electronic device to automatically store a captured image in response to detecting objects or faces of interest. In some embodiments, a motion-sensing component can be used to help align the lens.

### BACKGROUND OF THE INVENTION

This is directed to systems and methods for assisting a user in centering a photograph without the user viewing a preview of the photograph. In particular, systems and methods are provided for centering a camera that does not have viewfinder or that has a preview screen facing away from the user.

Many electronic devices have evolved and now include the ability to capture images. In particular, cellular telephones, personal assistants, and other portable electronic devices have integrated some or all of the functionality of cameras. Using a lens, the electronic devices can capture light and store images of the user's environment or of people or objects of interest to the user. In some cases, a user may wish to capture a photograph of himself or of objects or people behind or next to the user. Because the camera lens may be positioned on one end or side of the device, and the lens or screen for previewing images can typically be positioned on the opposite end or side of the device, a user may not be able to tell when the camera is properly oriented for a desired photograph.

To assist a user in properly orienting a camera lens, some electronic devices can include a secondary display on the same side or end as the camera lens. The secondary display can reflect the image captured by the camera lens, such that the user can orient the camera towards him and center the camera by reviewing the image displayed on the secondary display. The secondary display, however, can limit the size of the device, and cause the technical complexity and cost of the device to increase. Alternatively, other devices can include a mirror or reflective surface positioned on the same side or end as the camera lens. The shape and position of the reflective surface can be selected such that the object or person visible at the center of the surface is at the center of camera lens. The reflective surface, however, may not provide an indication of the orientation of the camera lens, and can provide limited feedback when the user viewing the reflective surface is not at the center of the image being captured.

### SUMMARY OF THE INVENTION

This is directed to systems and methods for accurately capturing desirable images using a camera when the user capturing the image cannot preview the image using either a viewfinder or a preview screen. For example, this is directed to systems and methods for users to take aesthetically pleasing self-portraits using an electronic device having preview mechanisms facing away from the user as the user captures the self-portrait.

In some embodiments, an electronic device can include a lens positioned on a first side of the device. The electronic device can also include a preview interface such as a viewfinder or a display on a second side opposite the first side of the device, such that the preview interface is operative to provide an indication of the image captured by the camera lens at a particular time. If a user wishes to take a self-portrait or capture an image of an object or person located behind the user, the user can direct the lens towards the user. Because the viewfinder or display can face the opposite side of the device, the user may not be able to see the image that will be taken by the lens.

To assist the user in properly orienting the camera lens before taking the photograph, the electronic device can include a face or object detection algorithm operative to analyze the image captured by the lens. The detection algorithm can identify one or more objects or faces in the captured image that are likely to be the objects or faces that the user wishes to capture using the camera lens, and provide recommendations as to how to tilt or move the device to center the desired objects or faces, or to improve the composition of the image. For example, the electronic device can provide audio or haptic feedback directing the user to move or tilt the device in a particular manner. Once the detecting algorithm determines that the desired object is properly positioned within the image captured by the lens, the electronic device can provide an indication for the user to direct the device to store or save the captured image (e.g., take the photograph), or automatically store the captured image.

In some embodiments, the user can initially set up the face or object detection algorithm to detect specific faces or objects in the image. For example, a user can direct the algorithm to detect a particular number of faces, or faces of particular people (e.g., from a library of faces). As another example, the user can direct the algorithm to detect a particular object (e.g., by providing a written description of the object, selecting the object from a library, or first taking a photograph of the object while viewing the display or viewfinder). As still another example, the electronic device can direct the algorithm to position detected items in accordance with a template.

To further enhance photographs, the electronic device can include one or more algorithms for calculating the luminosity and exposure of an image, determining the ideal or preferred composition of the image, and detecting extraneous objects within the image (e.g., a tree branch appearing to grow out of a person's head). The electronic device can then provide feedback to the user to change the orientation or position of the camera lens relative to the desired image to enhance the user's photograph. For example, the electronic device can direct a user to rotate by a given amount to change the relative orientation of the sun, re-position a landmark in the background of the image, or remove undesirable artifacts from the image (e.g., direct the user to move over to avoid a background object of a harsh color, such as a brightly colored artificial object in a natural background).

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an illustrative electronic device for capturing images in accordance with one embodiment of the invention;

FIGS. 2A and B are schematic views of an illustrative electronic device in accordance with one embodiment of the invention;

FIG. 3 is a schematic view of an illustrative display of a captured image to which a face detection algorithm is applied in accordance with one embodiment of the invention;

FIG. 4 is a schematic view of an illustrative setup display in accordance with one embodiment of the invention;

FIG. 5 is a flowchart of an illustrative process for storing a captured image using a face or object detection algorithm in accordance with one embodiment of the invention; and

FIG. 6 is a flowchart of an illustrative process for setting up a detection algorithm for user in capturing images in accordance with one embodiment of the invention.

### DETAILED DESCRIPTION

This is directed to systems and methods for storing a captured image without previewing the image before it is stored. For example, this is directed to systems and methods for taking self-portraits using an electronic device for which the image preview interface faces a side of the device other than the side on which the camera lens is placed.

An electronic device can be operative to capture images of a user's environment. For example, an electronic device can include an optical or digital lens operative to capture light reflected from the user's environment. The electronic device may be operative to store particular images captured by the lens for playback (e.g., to print or to send electronically for others to view). The electronic device can store images at any suitable time, including for example in response to receiving a user instruction (e.g., in response to a user providing an input using an input interface), after a delay (e.g., in a timer mode), or automatically (e.g., at particular moments in time or when the electronic device detects movement).

Before the electronic device stores a captured image (e.g., automatically or in response to a user instruction), the electronic device can provide the user with a preview of the captured image. In particular, the electronic device can include a preview interface operative to provide a representation of the image captured by the lens at each moment in time. To enable the user to easily aim the lens, preview a captured image, and provide an instruction to store the image without requiring extensive movement of the device, the preview interface can be positioned on a side of the device opposite the side of the lens. For example, the electronic device can include one or both of a display screen and a viewfinder on a side of the device opposite the side of the lens.

When a user wishes to capture a self-portrait, or capture an image of items behind the user such that the lens faces the user, the user may not be able to view the preview interface. In particular, if the electronic device includes a viewfinder or a display, the body of the electronic device can be located between the user and the viewfinder or the display. The user may then be forced to blindly guess how to position the electronic device to capture an appropriate image. To assist the user, the electronic device can include an object or face detection algorithm operative to analyze the detected image. Using the algorithm, the electronic device can provide indications to the user to tilt or move the lens such that a detected item, such as an object or face is positioned within the periphery of the captured image.

The object or face detection algorithm can be operative to direct the user to move the lens to position a detected face or object at any suitable position within the captured image. For example, the algorithm can be operative to assist a user in centering a detected face. As another example, the algorithm can be operative to position an object at a particular position within the image (e.g., place a background object near a corner of the image). As still another example, the algorithm can be operative to identify an ideal or preferred composition for an image, and direct the user to move the lens such that several detected faces or objects are placed in the image at preferred positions relative to each other, or such that different objects or faces don't overlap in undesirable manners (e.g., to avoid the appearance of trees growing out of a person's head). In some embodiments, the algorithm may be operative to detect the luminosity or exposure of an image, and direct the user to move the lens to correct a detected luminosity.

The electronic device can provide instructions for the user to move the camera lens using any suitable approach. For example, the electronic device can provide audio indications for moving or tilting the device in particular directions or by particular amounts (e.g., move device five inches left, tilt device up ten degrees). As another example, the electronic device can provide tactile or haptic instructions, such as changing a vibration pattern as the user gets closer to an optimal position (e.g., vibrations get more intense as the user moves the device towards a preferred position). As still another example, different combinations of outputs detectable by a user without seeing the display can be provided to direct the user to center the device.

The electronic device can store a captured image any suitable time. For example, the electronic device can store an image only in response to receiving a corresponding user instruction. To facilitate the user providing the instruction, the electronic device can activate a self-portrait mode in which the input associated with storing the image (e.g., taking a photograph) can be larger than when the user can see the display. For example, in the context of a touch-screen input interface, the electronic device can allow any contact of the touch-screen to constitute an instruction to store a captured image (e.g., instead of a touch screen region specifically associated with a displayed button). As another example, the electronic device can automatically store a captured image in response to detecting that a desirable image or object is detected within the captured image (e.g., the user centered his face in the cameral). The electronic device can require the device to remain substantially immobile for a given period of time to ensure that the captured image is clear and not blurry (e.g., especially in low-light conditions).

In some embodiments, the user can provide the detection algorithm with instructions as to what to detect in an image. For example, a user may access a setup screen in which the user can identify the number of faces expected in a photograph, the types of objects (e.g., shapes), the relative size of objects or faces, or any other information allowing the algorithm to determine what to detect. In some embodiments, the user can provide more specific information identifying specifically the objects or faces to detect. For example, a user can select a face from a photo library, or take an initial photograph (using the preview interface) of a face or object to detect in the self-portrait mode. As another example, the user can search for existing images of an object (e.g., search for images stored on a host device or in a remote source), or can describe in text or orally the object or face to detect (e.g., type “Yosemite half dome”).

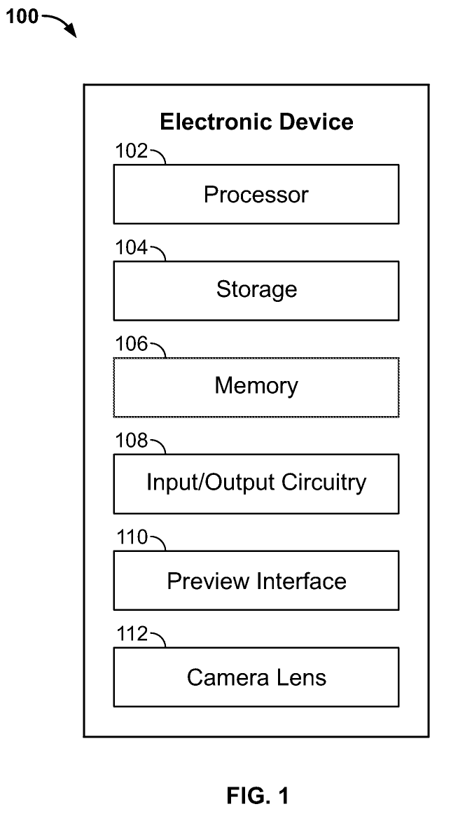

FIG. 1 is a schematic view of an illustrative electronic device for changing the display of information based on device movement in accordance with one embodiment of the invention. Electronic device 100 can include any suitable type of electronic device operative to display information to a user while detecting movement of the device. For example, electronic device 100 can include a media player such as an iPod® available by Apple Inc., of Cupertino, Calif., a cellular telephone, a personal e-mail or messaging device (e.g., a Blackberry® or a Sidekick®), an iPhone® available from Apple Inc., pocket-sized personal computers, personal digital assistants (PDAs), a laptop computer, a music recorder, a video recorder, a camera, radios, medical equipment, and any other portable electronic device capable of being moved by the user. The electronic device can be coupled to communications systems to access remote sources of information, such as remote databases (e.g., the Internet) or host devices (e.g., a desktop computer).

Electronic device 100 can include a processor or control circuitry 102, storage 104, memory 106 input/output circuitry 108, preview interface 110, and camera lens 112 as typically found in an electronic device of the type of electronic device 100. In some embodiments, one or more of electronic device components 100 can be combined or omitted (e.g., combine storage 104 and memory 106), or electronic device 100 can include other components not combined or included in those shown in FIG. 1 (e.g., communications circuitry, motion detection or sensing components, or positioning circuitry), or several instances of the components shown in FIG. 1. For the sake of simplicity, only one of each of the components is shown in FIG. 1.

Preview interface 110 can include any suitable type of display or interface for previewing an image captured by camera lens 112. In some embodiments, preview interface 130 can include a display embedded in or coupled to electronic device 100 (e.g., a removable display). The display can include, for example, a liquid crystal display (LCD), light emitting diode (LED) display, organic light-emitting diode (OLED) display, surface-conduction electron-emitter display (SED), carbon nanotubes, nanocrystal displays, or any other suitable type of display. Alternatively, the display can include a movable display or a projecting system for providing a display of content on a surface remote from electronic device 100, such as a video projector, head-up display, or three-dimensional (e.g., holographic) display. As another example, preview interface 130 can include a digital or mechanical viewfinder through which a user can see the images captured by camera lens 112. In some embodiments, the viewfinder can be of the type found in compact digital cameras, reflex cameras, or any other suitable still or video camera.

Camera lens 112 can include any suitable lens operative to capture images or video of the electronic device environment. For example, the electronic device can include an optical or digital lens for capturing light reflected from the user's environment. The captured light can be recorded as individual distinct images, or as consecutive video frames of a recording (e.g., several video frames constituting a primary frame and subsequent frames indicating the difference between the primary frame and the subsequent frames). The control circuitry may associate different metadata with the recorded images, including for example positioning information, device movement information, a time code, a device identifier, or any other suitable metadata. As used in this application, the term camera lens will be understood to mean a lens for capturing light from a device environment, or a lens and appropriate circuitry for converting captured light into an image that can be previewed or stored by the device.

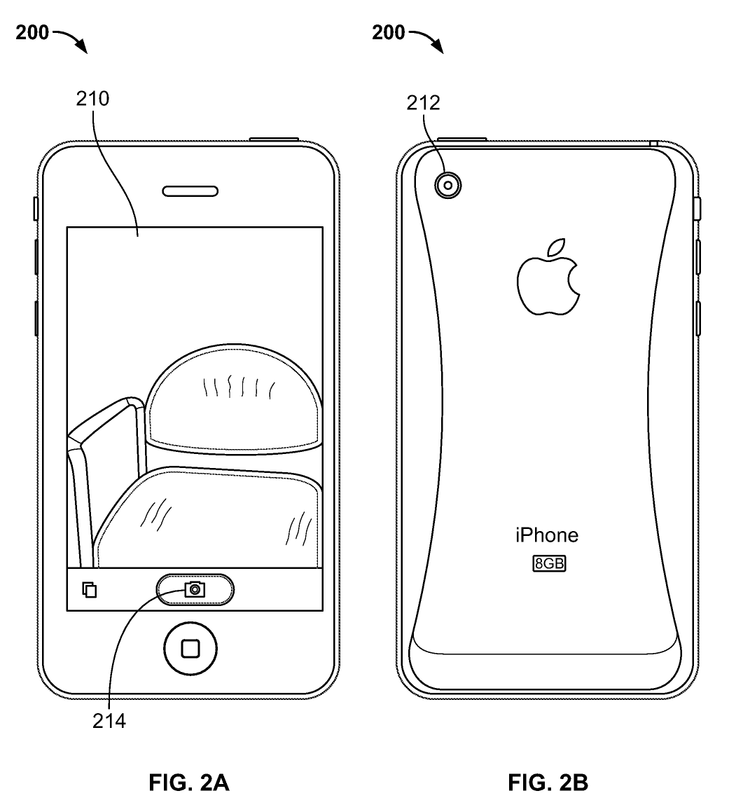

FIGS. 2A and B are schematic views of an illustrative electronic device in accordance with one embodiment of the invention. Electronic device 200 can include some or all of the features of electronic device 100 (FIG. 1). In particular, electronic device 200 can include display 210 on a first side of the device, and camera lens 212 extending from the opposite side of the device. When a camera mode is enabled, the electronic device can provide a preview of the image captured by lens 212 on display 210. The display can include option 214, which the user can select to store the captured image (e.g., take the photograph).

Using a device such as electronic device 200, a user may wish to take different types of photographs. For example, the user can wish to take self-portraits or capture images of objects behind the user. When the user turns the device so as to be facing the camera lens, however, the user may not see the preview mechanism and thus may not accurately preview an image before it is stored. Instead, the user can only guess the proper position of the device and hope that a captured image is suitable.

To assist the user in properly aligning the camera lens without requiring a secondary preview mechanism facing the user, the electronic device can include a face or object detection mechanism operative to analyze images detected by the camera lens, and provide instructions for the user to move or tilt the electronic device, and thus the camera lens, to properly position a detected face or object within the field of view of the camera lens. Because the face or object detection algorithm may not always be desirable (e.g., due to device resource requirements, or user interface considerations), the detection algorithm can be associated with a self-portrait mode that a user can enable to take self-portraits. The self-portrait mode can be activated in response to receiving a corresponding user input, or automatically in response to detecting the primary user of the device (e.g., the device owner, as determined from an initial device setup) in an image captured by the camera lens).

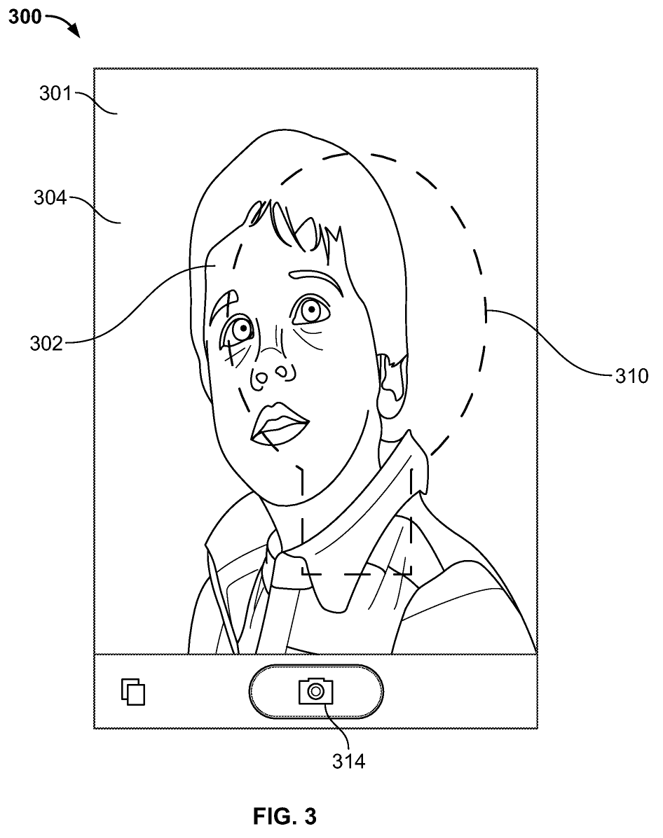

FIG. 3 is a schematic view of an illustrative display of a captured image to which a face detection algorithm is applied in accordance with one embodiment of the invention. Although the example of FIG. 3 describes face detection, it will be understood that it can also apply to object detection. Display 300 can include image 301 of person 302 and background 304. The user can direct the device to store a captured image (e.g., take a photograph) by providing an appropriate selection instruction, such as by selecting photograph option 314. Display 300 can include outline 310 depicting an item such as an object or face that the device attempts to identify (e.g., draw outline 310 over the relevant objects or faces detected by the detection algorithm). Alternatively, outline 310 can reflect the position within the field of view that a detected object or face is to have.

Analyzing a captured image, the electronic device can detect one or more faces or objects within the image. In some embodiments, the electronic device can detect only objects or faces in the foreground (e.g., ignoring background artifacts), or alternatively can detect both a particular face or object in the foreground and a particular face or object in the background (e.g., a self-portrait in front of a landmark). Once the electronic device has identified specific objects or faces in the captured image, the device can determine whether the identified objects or faces are in appropriate positions within the image. For example, the electronic device can determine whether a detected face is completely within the image. As another example, the electronic device can determine whether two detected items (e.g., a face and an object) are not overlapping. As still another example, the electronic device can determine whether the detecting algorithm detected all of the objects or faces expected to be in the image. As still yet another example, the electronic device can determine whether a detected object or face is large enough relative to the other objects or faces (e.g., whether two detected faces have similar sizes, or the ratio of a characteristic length of each face is not less than a particular value).

If the electronic device determines that the detected faces or objects are not properly positioned within the captured image, the electronic device can prompt the user to move or tilt the electronic device. In particular, the electronic device can determine, for one or more of the detected objects or faces, a preferred position in the image, and direct the user to move or tilt the electronic device so that the detected objects or faces are positioned in the preferred positions. In some embodiments, the electronic device can compute preferred positions for all of the detected items, determine a preferred composition for the items, and direct the user to move such that the detected items are positioned in accordance with the preferred composition (e.g., a face off-center to one side to show a landmark off-center to the other side).

The electronic device can provide instructions for the user to move or tilt the electronic device using any suitable approach. In particular, the electronic device can use approaches that do not require the user to see the preview interface (e.g., because the preview interface is not visible to the user in a self-portrait mode). In some embodiments, the electronic device can provide audio cues for the user to move or tilt the device. For example, the electronic device can direct the user to move or shift the device (and camera lens) by a particular amount in a particular direction (e.g., “move device up six inches and right two inches”). As another example, the electronic device can direct the user to move or tilt the device until a stop instruction is provided (e.g., tilt the device up until a beep is heard). In some embodiments, the electronic device can provide varying audio cues as the user moves towards or away from a preferred composition. For example, the user can provide an audio output at varying frequencies, rates, and volume based as the user moves the device. Each direction in which the user can move the device (e.g., move left/right, move up/down, shift left/right, shift up/down) can be associated with a different audio signal to indicate to the user the manner in which to move or tilt the device (e.g., consecutive beeps that become louder or closer in time as the user nears the device orientation associated with a preferred composition).

In some embodiments, the electronic device can direct the preview interface to change displayed information in a manner that allows a user to detect instructions without directly looking at the display. For example, the electronic device can direct a display to flash a pattern of lights (e.g., turn a bright light on and off) in a manner that is easily detected from reflections of the light in the user's environment. The light pattern can indicate, for example from the portions of the display that are illuminated, or the frequency or intensity of the illumination, the manner in which the user is to move to tilt the device to position detected objects and faces appropriately.

In some embodiments, the electronic device can instead or in addition use tactile feedback to direct the user to move or tilt the electronic device. For example, the electronic device can vibrate using different patterns and intensities to direct the user to move or tilt the device. As another example, other components within the electronic device operative to provide tactile feedback can be used (e.g., a component changing the temperature of the device based on its orientation, or a component providing different electrical shocks). Alternatively, any other mechanism for providing feedback to any of the user's senses can be used instead or in addition to those described above.

In some embodiments, the electronic device can be operative to not only determine whether specific detected items are properly positioned in a captured image, but also quantify attributes of the image and provide recommendations for improving the quantified attributes. For example, the electronic device can be operative to analyze the luminosity and exposure of an image (e.g., perform a spectral analysis) to determine an optimal position of the electronic device relative to the light source. As another example, the electronic device can analyze background components of an image (e.g., components not detected by the face and object detection algorithm) and determine whether background components adversely affect the appearance of a detected item. For example, the electronic device can determine whether a tree or pole is placed behind a user's head such that the user appears to have a tree growing from his head. As another example, the electronic device can determine whether a face or object is hiding portions of a writing (e.g., a billboard) such that the remaining portions spell an undesirable word. As still another example, the electronic device can use the output of an accelerometer or other motion-sensing component to determine whether the camera lens is properly aligned (e.g., whether the camera is horizontal or vertical, or within an acceptable range from horizontal or vertical, such as a few degrees).

Once the electronic device determines that a captured image is suitable (e.g., the proper items are detected and are correctly positioned), the electronic device can indicate to the user that the captured image can be stored. In response to receiving the indication, the electronic device can provide a storing instruction for storing the captured image (e.g., select an option for taking a photograph). Because the user may not see an option displayed on the preview interface (e.g., in the case of a touch screen device), the electronic device can increase the size of the selectable option when in the self-portrait mode. For example, the electronic device can interpret any input on the touch screen (e.g., not only inputs adjacent to the displayed option) as an instruction to store the captured image. In response to receiving the user instruction, the electronic device can store an image immediately or after a delay (e.g., to allow a user to reset after moving slightly to provide the input). In some embodiments, the electronic device can instead or in addition automatically store a captured image (e.g., automatically take a photograph) in response to determining that an image is appropriate.

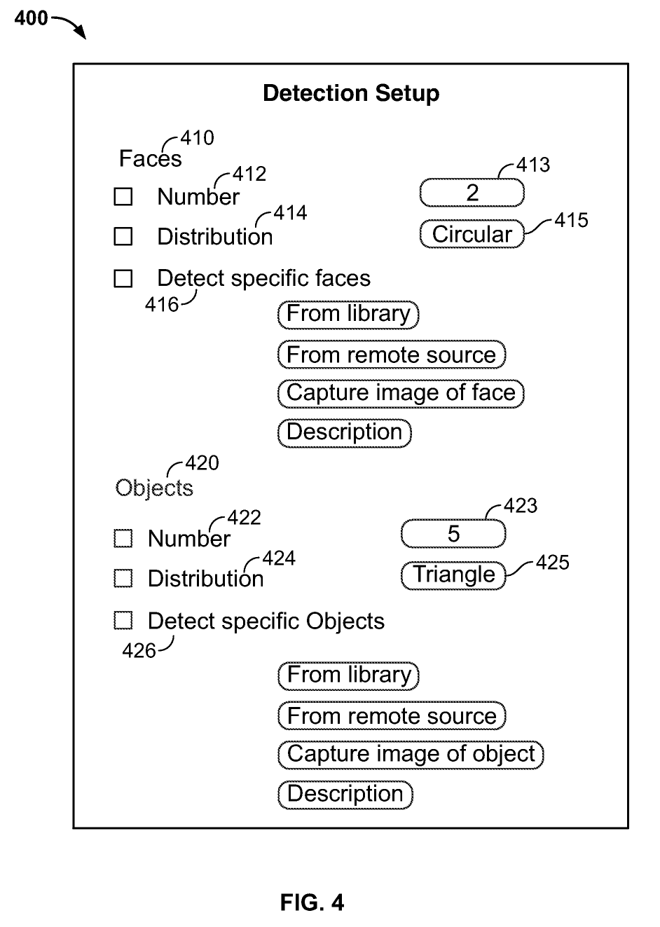

In some embodiments, a user may direct the detection algorithm to detect particular faces or objects in a captured image. For example, the user may wish to take a self-portrait that includes three people and a specific landmark in the background. To do so, the electronic device can provide a setup display on which the user can specify the items to detect. FIG. 4 is a schematic view of an illustrative setup display in accordance with one embodiment of the invention. A user can access display 400 using any suitable approach, including for example from an option displayed on a suitable display (e.g., a display for enabling a self-portrait mode). Display 400 can include options 410 for setting up facial detection, and options 420 for setting up object detection.

If a user wishes to capture an image that includes at least one face, the user can specify the number of faces 412 and the composition or distribution 414 of the faces using fields 413 and 415, respectively. Each possible distribution can include a template of face positions that the detection mechanism can direct the user to match (e.g., direct the user to move the device such that the positions of detected faces match the positions of faces within the template. In some embodiments, the user can direct the detection algorithm to detect specific faces using option 416. For example, the user can select a face from one or more of a locally or remotely stored library (e.g., previously captured photographs), a remote source (e.g., the Internet or a host device), by capturing an image of a face prior to entering the self-portrait mode (e.g., taking a photograph of a friend that will be in the self-portrait before enabling the self-portrait mode), or by describing (e.g., by typing or speaking) the face to detect. If the electronic device has access to a library of known faces, the user can provide name to instruct a face recognition algorithm to retrieve the characteristic information for a face associated with the provided name.

Similarly, a user can instead or in addition specify one or more objects to detect in an image. For example, the user can specify the number of objects 422 and the composition or distribution 424 of the objects using fields 423 and 425, respectively. Each possible distribution can include a template of object positions that the detection mechanism can direct the user to match (e.g., direct the user to move the device such that the positions of detected objects match the positions of objects within the template. In some embodiments, the user can direct the detection algorithm to detect specific objects using option 426. For example, the user can select an object from one or more of a locally or remotely stored library (e.g., previously captured photographs), a remote source (e.g., the Internet or a host device), by capturing an image of an object prior to entering the self-portrait mode (e.g., taking a photograph of a landmark that will be in the self-portrait before enabling the self-portrait mode), or by describing (e.g., by typing or speaking) the object to detect. In the context of objects, the user can identify specific objects by providing descriptions of basic shapes (e.g., a cylinder extending from a square).

Following a setup, the electronic device can determine if the detected items match the ones indicated in the setup. For example, the electronic device can determine whether the proper number of faces or objects were displayed, or whether the relative position of the items matches a template. In some embodiments, the electronic device can determine whether a detected item qualifies as one of the indicated items. For example, the electronic device can disregard faces or objects that are too small (e.g., having a characteristic length less than a predetermined value or a characteristic length less than a predetermined ration of characteristic lengths of other detected faces) and that are therefore likely to be in the background and not of interest. The electronic device can direct the user to pan the camera lens until all of the identified items are detected, or alternatively indicate to the user the items that were detected or are missing so that the user can adjust the camera.

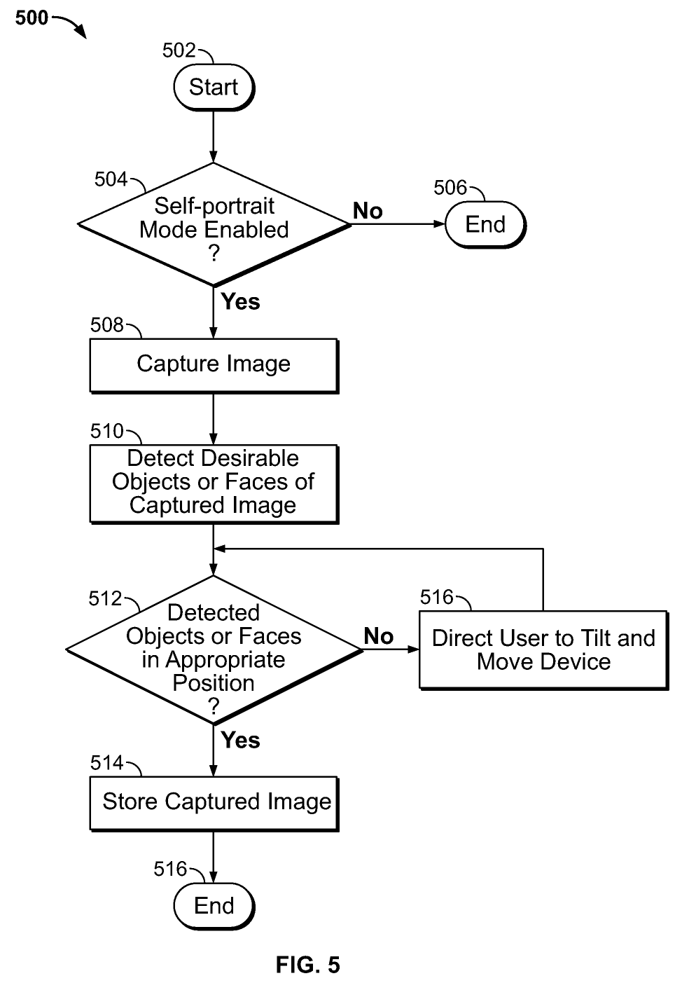

The following flowcharts illustrate the steps of various processes used in different embodiments of the invention. FIG. 5 is a flowchart of an illustrative process for storing a captured image using a face or object detection algorithm in accordance with one embodiment of the invention. Process 500 can begin at step 502. At step 504, the electronic device can determine whether a self-portrait mode is enabled. For example, the electronic device can determine whether the user provided an instruction to enable a self-portrait modem or whether the user's face is detected in an image captured by the camera lens. If the electronic device determines that the self-portrait mode is not enabled, process 500 can move to step 506 and end. If, at step 504, the electronic device instead determines that the self-portrait mode is enabled, process 500 can move to step 508.

At step 508, the electronic device can capture an image using a camera lens. For example, the electronic device can enable a camera lens to capture light reflected from the user's environment. At step 510, the electronic device can analyze the captured image and detect whether a desirable object or face is in the captured image. For example, the electronic device can determine whether any faces are detected in the captured image. At step 512, the electronic device can determine whether the detected objects or faces are in appropriate positions in the captured image. For example, the electronic device can determine whether the entirety of the detected items are in the image. As another example, the electronic device can determine whether a detected item is properly centered in the image. As still another example, the electronic device can determine whether several detected items overlap in the image. If the electronic device determines that the detected objects or faces are in appropriate positions, process 500 can move to step 514. At step 514, the electronic device can store the captured image (e.g., take a photograph automatically or in response to a user instruction) and end at step 506.

If, at step 512, the electronic device instead determines that the detected objects or faces are not in appropriate positions, process 500 can move to step 516. At step 516, the electronic device can direct the user to tilt and move the electronic device. For example, the electronic device can provide haptic or audio feedback indicating one or more of a direction and an amount by which to move or tilt the device to improve the positioning of the detected objects or faces within the image. The electronic device can determine the manner in which to move the device using any suitable approach, including for example by trying to position detected objects or faces at specific positions within the image (e.g., centered or slightly off-centered). Process 500 can then return to step 508 and determine whether, upon re-capturing an image after moving the device, the detected objects or faces are in appropriate positions.

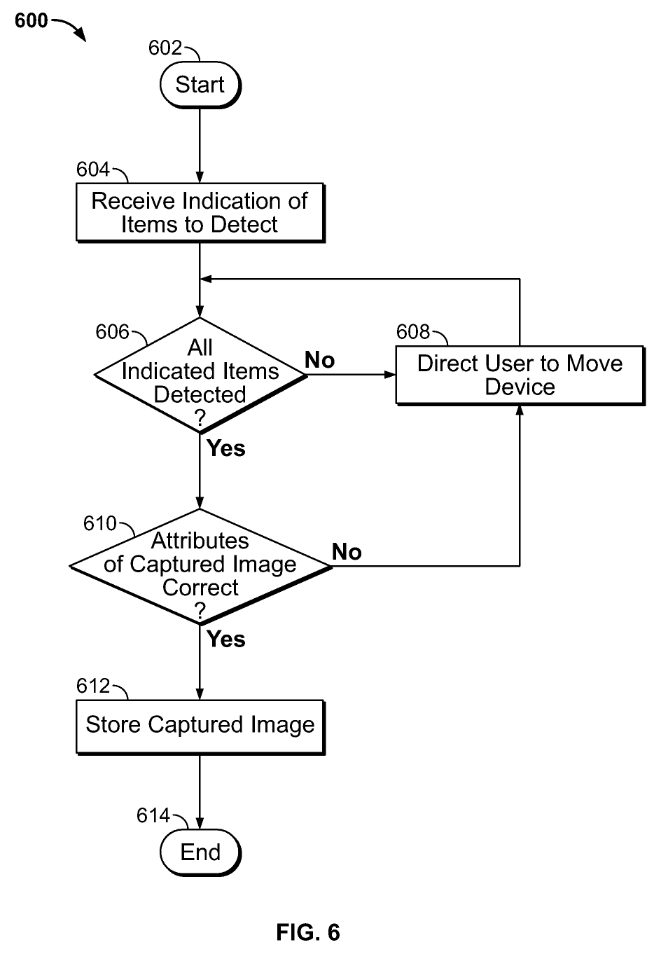

FIG. 6 is a flowchart of an illustrative process for setting up a detection algorithm for user in capturing images in accordance with one embodiment of the invention. Process 600 can begin at step 602. At step 604, the electronic device can receive an indication of items (e.g., faces, objects or both) to detect. For example, a user can specify a number of items to detect. As another example, the user can specify particular objects or faces to detect in an image (e.g., particular people or particular landmarks or objects). The user can specify the specific items using any suitable approach, including for example from existing images (e.g., locally or remotely stored, or generated as part of the setup process), or from a written or oral description. At step 606, the electronic device can determine whether all of the items indicated by the user were detected. For example, the electronic device can analyze an image captured with a camera lens and detect different faces or objects in the captured image. The electronic device can then determine whether the detected items match the items specified by the user at step 606. If the electronic device determines that all of the indicated items are not detected process 600 can move to step 608.

At step 608, the electronic device can direct the user to move the electronic device to change the orientation of the lens. For example, the electronic device can direct the user to move the electronic device in a manner to completely include a detected item in the captured image. As another example, the electronic device can direct the user to pan until the device detects a missing item that was indicated at step 604. Process 600 can then return to step 606 and determine whether all of the indicated items were detected.

If, at step 606, the electronic device instead determines that all of the indicated items are detected, process 600 can move to step 610. At step 610, the electronic device can determine whether the attributes of the captured image are correct. For example, the electronic device can determine whether one or more of the lighting, exposure, composition, and other attributes of an image captured by a camera lens. If the electronic device determines that the attributes of the captured image are incorrect or inadequate, process 600 can return to step 608 at which the electronic device can direct the user to move the electronic device to change the attributes of the images captured by the camera lens.

If, at step 610, the electronic device instead determines that the attributes of the captured image are correct or adequate, process 600 can move to step 612. At step 612, the electronic device can store the captured image. For example, the electronic device can automatically store a captured image in response to determining that a captured image is correct. As another example, the electronic device can store a captured image in response to receiving a user instruction (e.g., provided using an input mechanism). Process 600 can then end at step 614.

The above described embodiments of the invention are presented for purposes of illustration and not of limitation, and the present invention is limited only by the claims which follow.

What is claimed is:

1. A method for capturing an image without first previewing the image, comprising:
capturing an image using a camera;
detecting at least one object other than a face in the captured image using a detection algorithm; and
directing a user to move the camera to change the position of the detected at least one object in the captured image.

2. The method of claim 1, further comprising:
determining that the position of the detected object in the captured image is appropriate; and
storing the captured image.

3. The method of claim 2, wherein determining further comprises:
determining that the object is positioned adjacent to an object position in a template.

4. The method of claim 2, wherein storing further comprises:
at least one of automatically storing the captured image in response to determining and receiving a user instruction to store the captured image.

5. The method of claim 1, further comprising:
receiving an indication of the number of objects to detect; and
determining whether the indicated number of objects was detected.

6. The method of claim 5, further comprising:
determining that fewer than the indicated number of objects were detected; and
directing the user to move the electronic device until at least the indicated number of objects is detected.

7. The method of claim 5, wherein determining further comprises:
comparing the relative sizes of the detected objects; and
disregarding disproportionately small objects.

8. The method of claim 7, wherein:
a characteristic measurement of the disproportionately small objects is smaller than a minimum measurement.

9. The method of claim 7, wherein:
a characteristic measurement of the disproportionately small objects is less than a predetermined ratio of a characteristic measurement of at least one other detected object.

10. The method of claim 1, wherein directing further comprises:
providing audio instructions indicating at least one of a direction and amount by which to move the electronic device.

11. An electronic device operative to capture images, comprising:
a camera facing a first side of the device;
a preview interface positioned on a second side of the device, wherein the preview interface is not viewable when facing the camera;
a storage operative to store data; and
a processor operative to:
receive identifying information for a specific item, wherein the item comprises at least one of a face and an object;
direct the camera to capture an image;
analyze the captured image to detect at least one item;
compare the at least one item to the received identifying information for the specific item;
determine that the at least one detected item matches the received identifying information; and
direct the storage to store the captured image.

12. The electronic device of claim 11, wherein the processor is further operative to:
receive a number of items to detect; and
determine whether the number of items detected is at least equal to the received number.

13. The electronic device of claim 12, wherein the processor is further operative to:
receive a distribution of positions in an image for the items; and
determine whether the position of the detected at least one item matches a position of the received distribution of positions.

14. The electronic device of claim 11, wherein the processor is further operative to:
determine whether the detected at least one item is properly positioned within the captured image;
direct the user to move the electronic device to change the orientation of the camera in response to determining that the detected at least one items is not properly positioned; and
direct the camera to capture a revised image.

15. The electronic device of claim 14, wherein the processor is further operative to:
analyze the revised image to detect the at least one item;
determine that the position of the detected at least one item in the revised image is correct; and
direct the storage to store the revised image.

16. The electronic device of claim 11, wherein the processor is further operative to:
automatically direct the storage to store the image in response to determining.

17. The electronic device of claim 11, wherein:
the electronic device further comprises a motion-sensing component; and
the processor is further operative to:
receive the output of the motion-sensing component;
determine that the orientation of the electronic device is inappropriately angled in response to receiving; and
direct the user to tilt the electronic device to change the orientation of the device.

18. The electronic device of claim 17, wherein the processor is further operative to:
determine that the orientation of the electronic device is within a predetermined range from one of horizontal and vertical.

19. A method for storing an image captured by a camera facing the user without a preview mechanism visible to the user, comprising:
capturing an image of an item using a camera;
identifying at least one item in the image;
detecting the position of the identified at least one item within the image;
comparing the detected position with a template position;
determining, from a motion-sensing component output, whether the orientation of the electronic device relative to the ground is within a predetermined range; and
providing an indication to change the orientation of the camera in response to determining.

20. The method of claim 19, further comprising:
receiving the template, wherein the template comprises a plurality of appropriate positions for detected items.

21. The method of claim 19, wherein providing further comprises:
determining that the detected position does not match the template position;
determining a direction in which to move the camera for the detected position to match the template position;
determining an amount by which to move the camera for the detected position to match the template position; and
providing an indication reflecting the determined direction and the determined amount.

22. The method of claim 21, wherein providing further comprises:
providing at least one of audio instructions and haptic instructions.

23. Computer readable media for capturing an image without previewing the image, comprising a computer-readable instructions for:
capturing an image using a camera;
detecting at least one object other than a face in the captured image using a detection algorithm; and
directing a user to move the camera to change the position of the detected at least one object in the captured image.
